(19) United States
(12) Patent Application Publication
(10) Pub. No.: US 2006/0201038 A1
(43) Pub. Date: Sep. 14, 2006

(54) Vehicular display support device

(76) Inventor: Michael V. Haubert, Mount Holly, NC (US)

Correspondence Address: Michael V Haubert, 133 Lighthouse Road, Mount Holly, NC, 28120, US

(21) Appl. No.: 11/351,663

(22) Filed: Feb. 10, 2006

Related U.S. Application Data
(60) Provisional application No. 60/659,585, filed on Mar. 8, 2005.
(60) Provisional application No. 60/684,467, filed on May 25, 2005.
(60) Provisional application No. 60/709,250, filed on Aug. 17, 2005.

(51) Int. Cl. G09F 21/04

(52) U.S. Cl. 40/591

(57) ABSTRACT

A structural device to which is fastened a planar display or frame to support a planer display. The structural device attaches to a vehicle so as to support a planar display or frame to support a planer display in the plane parallel to the rear or front surfaces of the vehicle. The structural device is comprised of a singular structural member or a plurality of concatenated structural members that are static, exhibit rotational or linear articulation, or exhibit rotational and linear articulation. The structural device attaches to the vehicle by means of the device commonly known as a trailer hitch receiver, a trailer hitch ball receiver, a step bumper hitch ball receiver, a tongue hitch ball receiver.

### CROSS-REFERENCES TO RELATED APPLICATIONS

This application claims the benefit of Provisional Applications: U.S. Application No. 60/659,585 filed Mar. 8, 2005; U.S. Application No. 60/684,467 filed May 25, 2005; U.S. Application No. 60/709,250 filed Aug. 17, 2005.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

1. Field of Invention

This invention is a vehicular display support device configured to act as or support a post or posts to which planer displays or frames that support planer displays are attached. The device connects to a vehicle equipped with a trailer hitch and connects to a vehicle by means of the vehicles trailer hitch apparatus. The device supports a planer display for presentation to vehicular occupants and pedestrians to the rear of or to the front of the vehicle equipped with this device.

2. Discussion of Relevant Art

Long before the introduction of motorized vehicles people recognized the opportunity vehicles presented in the promotion of information. Notable examples are circus wagons and political campaign wagons. It was only natural these methods of communication would be applied to motorized vehicles upon their introduction. To date most of the promotion is accomplished by applying a planer display, on which the message was applied, to the broad surfaces present on vehicles or is directly applied to the vehicle surfaces. While effective these devices are limited in their ability to rapidly remove the message from the vehicle. This inability to rapidly remove the message from the vehicle limits the utilization of the vehicle, particularly if the message is commercial in nature. Many public places, like National Parks, prohibit commercial vehicles within their boundaries.

Recently three products have been developed that differ from the traditional method described above. There is disclosed in U.S. Pat. No. 5,979,094 a device entitled: PROTECTIVE TRAILER HITCH LIGHTED SIGN. The patent shows an ornamental protective lighted sign attached to a trailer hitch. A trailer hitch protector with a sign, a logo, an ornament and a message affixed, with back lighting, is well known art. One of the features that distinguishes U.S. Pat. No. 5,979,094 is the ability to remove the sign from the from the trailer hitch protector. This invention is primarily a trailer hitch protector with a removable sign. This location of this invention on the bearing vehicle is at or below the bumper of the vehicle. The invention being applied for in this application allows for the planer display to be located above the bumper and clearly viewable for vehicular occupants and pedestrians to the rear of or to the front of the bearing vehicle.

There is disclosed in U.S. Pat. No. 6,643,963 a device entitled: TRAILING SIGN SUPPORT SYSTEM. The patent shows a vehicle mounted, rearward cantilevered frame for holding planer display material oriented to present the planer display in profile to pedestrians on either side of the bearing vehicle. This invention presents the planer display in a plane perpendicular the rear surface of the bearing vehicle. This invention supports the planer display by means of a member projecting from the rear of the bearing vehicle. The invention being applied for in this application, because of its proximity to the bearing vehicle, reduces the potential of lancing a trailing vehicle and pedestrians.

A product entitled BILLBOARD TRUCK RACK is available from a company known as U.S. Rack LLC. The product is a rack for holding a billboard, attached to a vehicle by means of the trailer hitch receiver. The product presents the rack in a plane parallel to the rear surface of the vehicle. The product comprises of two primary components: a rack with two pegs attached, in a perpendicular orientation, to the lower horizontal rack member and oriented in the same plane as the billboard; an apparatus that is coaxially captivated a trailer hitch receiver and presents two female receptacles in a upward vertical orientation attached to a member attached perpendicularly to the apparatus engaging the trailer hitch receiver. When the product is attached to a vehicle the two pegs engage the two female receivers. The two pegs along with the two female receivers facilitates the removal if the rack from the vehicle. With the design as it exists the pegs are integral to the rack and should be considered an element in the rack design. The invention being applied for in this application differs fundamentally in that it is configured to act as or support a singular post or a plurality of posts and is configured for a singular planer display or a plurality of planer displays to be attached.

### BRIEF SUMMARY OF THE INVENTION

The present invention overcomes deficiencies in relevant art by providing a vehicle mounted display support device that presents a planer display in a plane parallel to the rear surface of the bearing vehicle at an elevation above the road surface so as to be readily viewable to vehicular occupants and pedestrians to the rear of or to the front of the vehicle equipped with this device without. The invention readily attaches to a vehicle by means of the device commonly known as a trailer hitch receiver, a trailer hitch ball receiver, a step bumper hitch ball receiver, a tongue hitch ball receiver. The invention acts as or supports a singular post or a plurality of posts to which planar displays or frames to support planer displays are attached. The invention is either fixed in construction allowing no articulation once attached to the bearing vehicle or is constructed with mechanical members that permit rotational and/or linear articulation. The articulating feature of the invention allows the device to move so as to not present itself as an obstacle to the operation of the vehicles doors, hatches, gates, or lids. A spoiler can be attached to the invention so as to offset pressure differentials that may occur as the planer display with the bearing vehicle moves through the air. The invention is equipped with a means of transferring electrical power to devices such as wiper mechanisms, marquee lighting, neon lighting, motors and other types of electrical and electromechanical apparatuses. The invention is equipped with a means of transferring electronic information to devices such as cathode ray tube displays, flat screen displays and other types of electronic appliances. The invention is equipped with a means of transferring electrical signals to electrical and electronic appliances.

### BRIEF DESCRIPTION OF THE SEVERAL VIEWS OF THE DRAWINGS

FIG. 1 shows a single post non-articulating variation of the current invention as it would appear to an outside observer if it were not attached to a vehicle.

FIG. 2 shows a single post non-articulating variation of the current invention as it would appear to an outside observer if it were not attached to a vehicle.

FIG. 3 shows a multiple post non-articulating variation of the current invention as it would appear to an outside observer if it were not attached to a vehicle.

FIG. 4 shows a single post non-articulating variation of the current invention as it would appear to an outside observer if it were not attached to a vehicle.

FIG. 5 shows a multiple post non-articulating variation of the current invention as it would appear to an outside observer if it were not attached to a vehicle.

FIG. 6 shows a single post non-articulating variation of the current invention as it would appear to an outside observer if it were not attached to a vehicle.

FIG. 7 shows a single post non-articulating variation of the current invention as it would appear to an outside observer if it were not attached to a vehicle.

FIG. 8 shows a single post rotationally articulating variation of the current invention as it would appear to an outside observer if it were not attached to a vehicle.

FIG. 9 shows a single post rotationally articulating variation of the current invention as it would appear to an outside observer if it were not attached to a vehicle.

FIG. 10 shows a single post rotationally articulating variation of the current invention as it would appear to an outside observer if it were not attached to a vehicle.

FIG. 11 shows a single post rotationally articulating variation of the current invention as it would appear to an outside observer if it were not attached to a vehicle.

FIG. 12 shows a single post rotationally articulating variation of the current invention as it would appear to an outside observer if it were not attached to a vehicle.

FIG. 13 shows a multiple post rotationally articulating variation of the current invention as it would appear to an outside observer if it were not attached to a vehicle.

FIG. 14 shows a multiple post rotationally articulating variation of the current invention as it would appear to an outside observer if it were not attached to a vehicle.

FIG. 15A shows a single post rotationally and lineally articulating variation of the current invention as it would appear to an outside observer if it were not attached to a vehicle.

FIG. 15B shows a single post rotationally and lineally articulating variation of the current invention as it would appear to an outside observer if it were not attached to a vehicle.

FIG. 16A shows a single post rotationally and lineally articulating variation of the current invention as it would appear to an outside observer if it were not attached to a vehicle.

FIG. 16B shows a single post rotationally and lineally articulating variation of the current invention as it would appear to an outside observer if it were not attached to a vehicle.

FIG. 17A shows a non-articulating single post holder variation of the current invention without a post and planer display as it would appear to an outside observer if it were not attached to a vehicle.

FIG. 17B shows a non-articulating single post holder variation of the current invention with a post and planer display as it would appear to an outside observer if it were not attached to a vehicle.

FIG. 18A shows a non-articulating single post holder variation of the current invention without a post and planer display as it would appear to an outside observer if it were not attached to a vehicle.

FIG. 18B shows a non-articulating single post holder variation of the current invention with a post and planer display as it would appear to an outside observer if it were not attached to a vehicle.

FIG. 19A shows a non-articulating single post holder variation of the current invention without a post and planer display as it would appear to an outside observer if it were not attached to a vehicle.

FIG. 19B shows a non-articulating single post holder variation of the current invention with a post and planer display as it would appear to an outside observer if it were not attached to a vehicle.

FIG. 20A shows a non-articulating multiple post holder variation of the current invention without posts and a planer display as it would appear to an outside observer if it were not attached to a vehicle.

FIG. 20B shows a non-articulating multiple post holder variation of the current invention with posts and a planer display as it would appear to an outside observer if it were not attached to a vehicle.

FIG. 21A shows a non-articulating multiple post holder variation of the current invention without posts and a planer display as it would appear to an outside observer if it were not attached to a vehicle.

FIG. 21B shows a non-articulating multiple post holder variation of the current invention with posts and a planer display as it would appear to an outside observer if it were not attached to a vehicle.

FIG. 22A shows a non-articulating multiple post holder variation of the current invention without posts and a planer display as it would appear to an outside observer if it were not attached to a vehicle.

FIG. 22B shows a non-articulating multiple post holder variation of the current invention with posts and a planer display as it would appear to an outside observer if it were not attached to a vehicle.

FIG. 23A shows a non-articulating multiple post holder variation of the current invention without posts and a planer display as it would appear to an outside observer if it were not attached to a vehicle.

FIG. 23B shows a non-articulating multiple post holder variation of the current invention with posts and a planer display as it would appear to an outside observer if it were not attached to a vehicle.

FIG. 24A shows a non-articulating single post holder variation of the current invention without a post and planer display as it would appear to an outside observer if it were not attached to a vehicle.

FIG. 24B shows a non-articulating single post holder variation of the current invention without a post and planer display as it would appear to an outside observer if it were not attached to a vehicle.

FIG. 24C shows a non-articulating single post holder variation of the current invention with a post and planer display as it would appear to an outside observer if it were not attached to a vehicle.

FIG. 25A shows a non-articulating single post holder variation of the current invention without a post and planer display as it would appear to an outside observer if it were not attached to a vehicle.

FIG. 25B shows a non-articulating single post holder variation of the current invention without a post and planer display as it would appear to an outside observer if it were not attached to a vehicle.

FIG. 25C shows a non-articulating single post holder variation of the current invention with a post and planer display as it would appear to an outside observer if it were not attached to a vehicle.

### DETAILED DESCRIPTION OF THE INVENTION

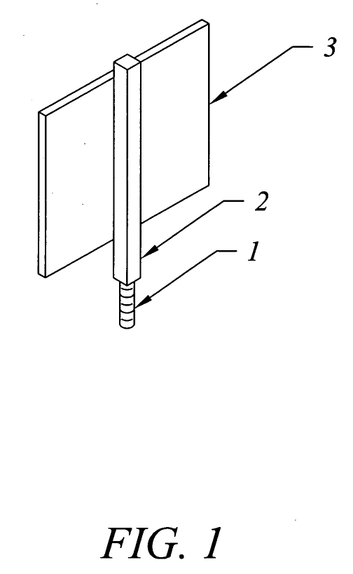

Refer to FIG. 1. This invention attaches to the vehicle by means of the hitch ball receiver and is fastened to the vehicle by means of a threaded fastener (1) that engages the hitch ball receiver and the display support device. The structural member (2) of the display support device attached to the vehicle projects perpendicular or near perpendicular to the horizontal plane of the vehicle and coaxial or near coaxial to the centerline of the bore of the hitch ball receiver. Attached to this structural member is a planar display (3).

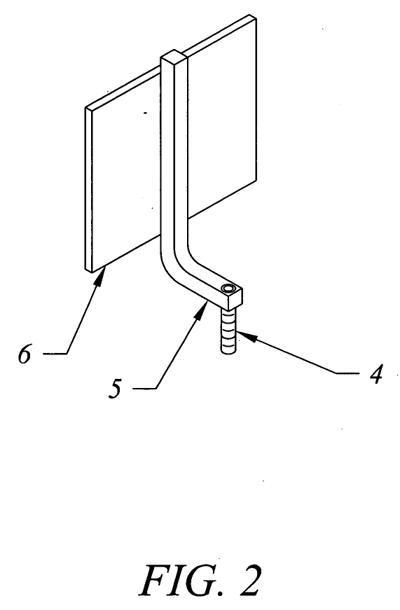

Refer to FIG. 2. This invention attaches to the vehicle by means of the hitch ball receiver and is fastened to the vehicle by means of a threaded fastener (4) that engages the hitch ball receiver and the display support device. The structural member (5) of the display support device attached to the vehicle projects parallel or near parallel to the horizontal plane of the vehicle and parallel or near parallel to the vertical longitudinal plane of the vehicle. At the end opposite the trailer hitch structural member (5) is fabricated or bent perpendicular or near perpendicular to the portion attached to the vehicle and projects perpendicular or near perpendicular to the horizontal plane of the vehicle. Structural member (5) consists of a singular or a plurality of structural components. Attached to the portion of structural member (5) that is perpendicular or near perpendicular to the horizontal plane of the vehicle is a planar display (6).

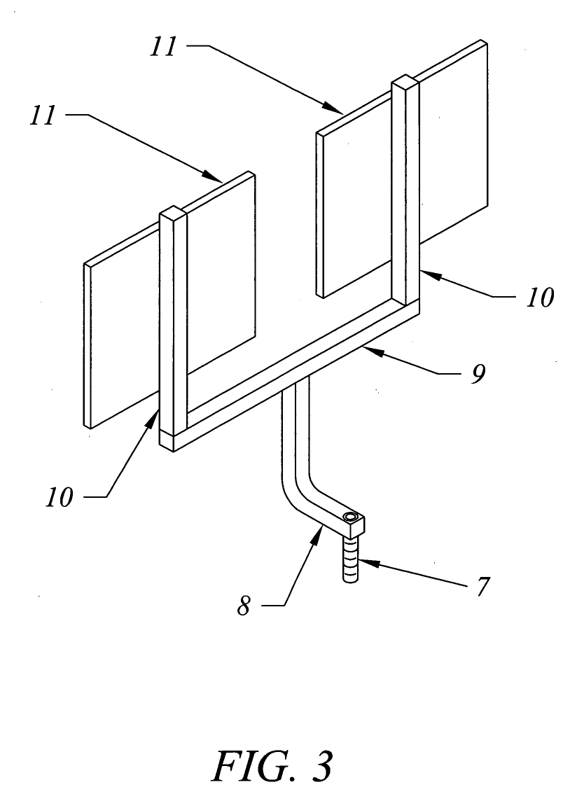

Refer to FIG. 3. This invention attaches to the vehicle by means of the hitch ball receiver and is fastened to the vehicle by means of a threaded fastener (7) that engages the hitch ball receiver and the display support device. The structural member (8) of the display support device attached to the vehicle projects parallel or near parallel to the horizontal plane of the vehicle and parallel or near parallel to the vertical longitudinal plane of the vehicle. At the end opposite the trailer hitch structural member (8) is fabricated or bent perpendicular or near perpendicular to the portion attached to the vehicle and projects perpendicular or near perpendicular to the horizontal plane of the vehicle. Attached to the portion of structural member (8) that is perpendicular or near perpendicular to the horizontal plane of the vehicle and attached to the end opposite the trailer hitch or attached to the surface is a structural member (9) projecting parallel or near parallel to the horizontal plane of the vehicle and perpendicular or near perpendicular to the vertical longitudinal plane of the vehicle. Attached to structural member (9) is a singular or a plurality of structural members (10) projecting perpendicular or near perpendicular to the horizontal plane of the vehicle. Attached to or supported between structural members (10) is a singular planar display or a plurality of planar displays (11).

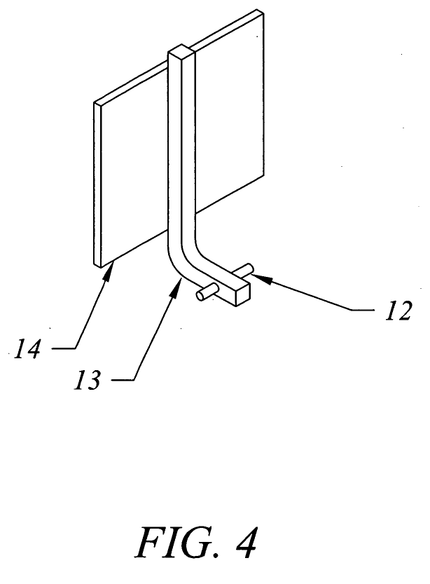

Refer to FIG. 4. This invention attaches to the vehicle by means of a structural member (13) that is a removable male plug that engages the trailer hitch with a square, rectangular, or round tubular female receptacle and is secured in place with a pin or similar device (12). The structural member (13) of the display support device that is a removable male plug when attached to the vehicle projects parallel or near parallel to the horizontal plane of the vehicle and parallel or near parallel to the vertical longitudinal plane of the vehicle. At the end opposite the trailer hitch structural member (13) is fabricated or bent perpendicular or near perpendicular to the portion attached to the vehicle and projects perpendicular or near perpendicular to the horizontal plane of the vehicle. Structural member (13) consists of a singular or a plurality of structural components. Attached to the portion of structural member (13) that is perpendicular or near perpendicular to the horizontal plane of the vehicle is a planar display (14).

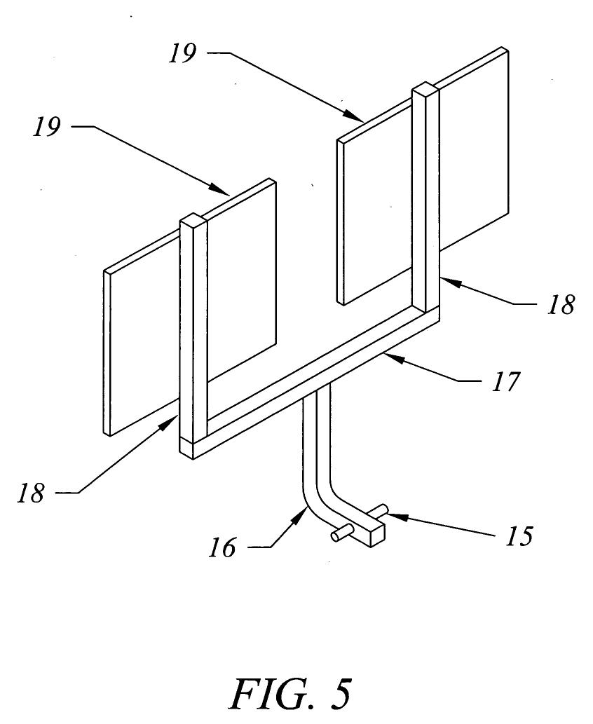

Refer to FIG. 5. This invention attaches to the vehicle by means of a structural member (16) that is a removable male plug that engages the trailer hitch with a square, rectangular, or round tubular female receptacle and is secured in place with a pin or similar device (15). The structural member (16) of the display support device that is a removable male plug when attached to the vehicle projects parallel or near parallel to the horizontal plane of the vehicle and parallel or near parallel to the vertical longitudinal plane of the vehicle. At the end opposite the trailer hitch structural member (16) is fabricated or bent perpendicular or near perpendicular to the portion attached to the vehicle and projects perpendicular or near perpendicular to the horizontal plane of the vehicle. Structural member (16) consists of a singular or a plurality of structural components. Attached to the portion of structural member (16) that is perpendicular or near perpendicular to the horizontal plane of the vehicle and attached to the end opposite the trailer hitch or attached to the surface is a structural member (17) projecting parallel or near parallel to the horizontal plane of the vehicle and perpendicular or near perpendicular to the vertical longitudinal plane of the vehicle. Attached to structural member (17) is a singular or a plurality of structural members (18) projecting perpendicular or near perpendicular to the horizontal plane of the vehicle. Attached to or supported between structural members (18) is a singular planar display or a plurality of planar displays (19).

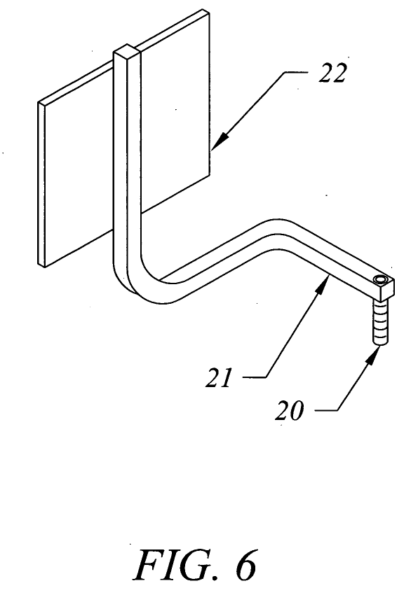

Refer to FIG. 6. This invention attaches to the vehicle by means of the hitch ball receiver and is fastened to the vehicle by means of a threaded fastener (20) that engages the hitch ball receiver and the display support device. The structural member (21) of the display support device attached to the vehicle projects parallel or near parallel to the horizontal plane of the vehicle and parallel or near parallel to the vertical longitudinal plane of the vehicle, then projects parallel or near parallel to the horizontal plane of the vehicle and perpendicular or near perpendicular to the vertical longitudinal plane of the vehicle, then projects perpendicular or near perpendicular to the horizontal plane of the vehicle and parallel or near parallel to the vertical longitudinal plane of the vehicle. Structural member (21) consists of a singular or a plurality of structural components. Attached to structural member (21) is planer display (22).

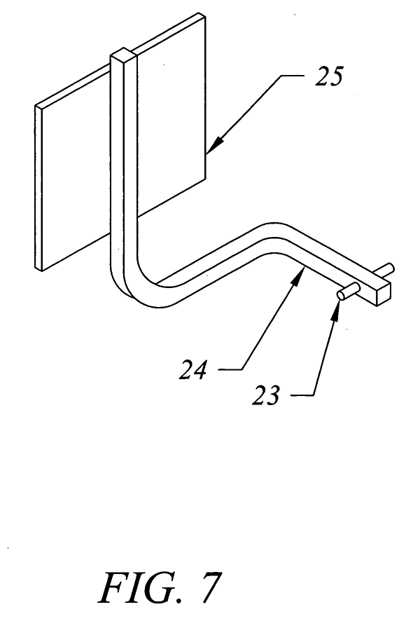

Refer to FIG. 7. This invention attaches to the vehicle by means of a structural member (24) that is a removable male plug that engages the trailer hitch with a square, rectangular, or round tubular female receptacle and is secured in place with a pin or similar device (23). The structural member (24) of the display support device that is a removable male plug when attached to the vehicle projects parallel or near parallel to the horizontal plane of the vehicle and parallel or near parallel to the vertical longitudinal plane of the vehicle, then projects parallel or near parallel to the horizontal plane of the vehicle and perpendicular or near perpendicular to the vertical longitudinal plane of the vehicle, then projects perpendicular or near perpendicular to the horizontal plane of the vehicle and parallel or near parallel to the vertical longitudinal plane of the vehicle. Structural member (24) consists of a singular or a plurality of structural components. Attached to structural member (24) is planer display (25).

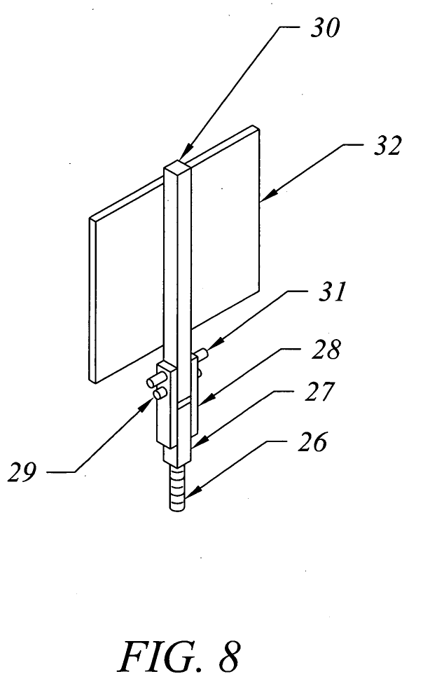

Refer to FIG. 8. This invention attaches to the vehicle by means of the hitch ball receiver and is fastened to the vehicle by means of a threaded fastener (26) that engages the hitch ball receiver and the display support device. The structural member (27) of the display support device attached to the vehicle projects perpendicular or near perpendicular to the horizontal plane of the vehicle and coaxial or near coaxial to the centerline of the bore of the hitch ball receiver. Attached to structural member (27) is a hinge (28) with an axis of rotation perpendicular or near perpendicular to the vertical longitudinal plane of the vehicle and around hinge pin (29). Attached to said hinge is a structural member (30) that rotates about said hinge pin and projects perpendicular or near perpendicular to the horizontal plane of the vehicle and coaxial or near coaxial to the centerline of the bore of the hitch ball receiver and is secured in position by a pin or similar device (31). Attached to structural member (30) is a planar display (32).

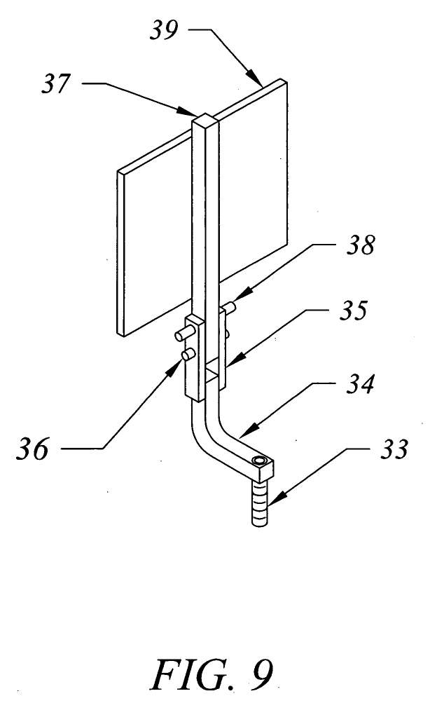

Refer to FIG. 9. This invention attaches to the vehicle by means of the hitch ball receiver and is fastened to the vehicle by means of a threaded fastener (33) that engages the hitch ball receiver and the display support device. The structural member (34) of the display support device attached to the vehicle projects parallel or near parallel to the horizontal plane of the vehicle and parallel or near parallel to the vertical longitudinal plane of the vehicle. At the end opposite the trailer hitch structural member (34) is fabricated or bent perpendicular or near perpendicular to the portion attached to the vehicle and projects perpendicular or near perpendicular to the horizontal plane of the vehicle. Structural member (34) consists of a singular or a plurality of structural components. Attached to the portion of structural member (34) that is perpendicular or near perpendicular to the horizontal plane of the vehicle is a hinge (35) with an axis of rotation perpendicular or near perpendicular to the vertical longitudinal plane of the vehicle and around hinge pin (36). Attached to said hinge is a structural member (37) that rotates about said hinge pin and projects perpendicular or near perpendicular to the horizontal plane of the vehicle and is secured in position by a pin or similar device (38). Attached to structural member (37) is a planar display (39).

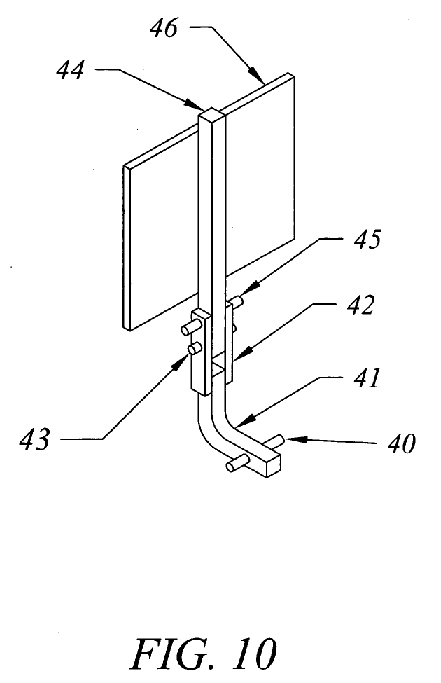

Refer to FIG. 10. This invention attaches to the vehicle by means of a structural member (41) that is a removable male plug that engages the trailer hitch with a square, rectangular, or round tubular female receptacle and is secured in place with a pin or similar device (40). The structural member (41) of the display support device that is a removable male plug when attached to the vehicle projects parallel or near parallel to the horizontal plane of the vehicle and parallel or near parallel to the vertical longitudinal plane of the vehicle. At the end opposite the trailer hitch structural member (41) is fabricated or bent perpendicular or near perpendicular to the portion attached to the vehicle and projects perpendicular or near perpendicular to the horizontal plane of the vehicle. Structural member (41) consists of a singular or a plurality of structural components. Attached to the portion of structural member (41) that is perpendicular or near perpendicular to the horizontal plane of the vehicle is a hinge (42) with an axis of rotation perpendicular or near perpendicular to the vertical longitudinal plane of the vehicle and around hinge pin (43). Attached to said hinge is a structural member (44) that rotates about said hinge pin and projects perpendicular or near perpendicular to the horizontal plane of the vehicle and is secured in position by a pin or similar device (45). Attached to structural member (44) is a planar display (46).

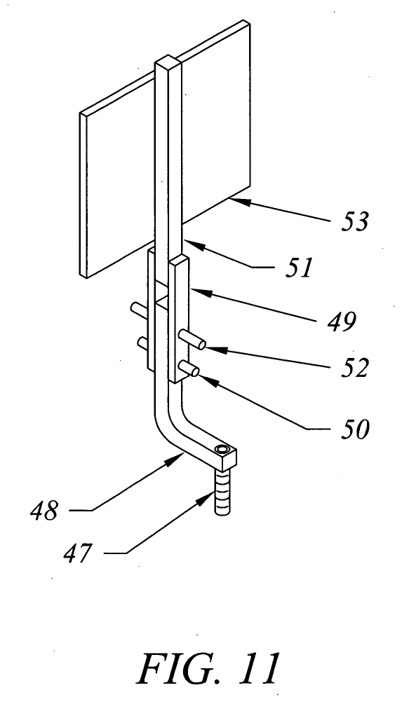

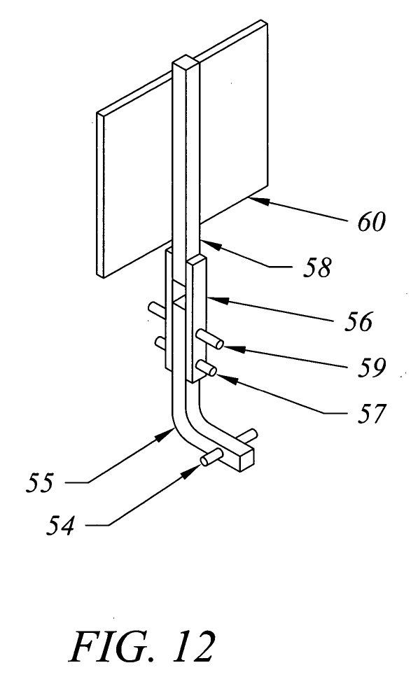

Refer to FIG. 11. This invention attaches to the vehicle by means of the hitch ball receiver and is fastened to the vehicle by means of a threaded fastener (47) that engages the hitch ball receiver and the display support device. The structural member (48) of the display support device attached to the vehicle projects parallel or near parallel to the horizontal plane of the vehicle and parallel or near parallel to the vertical longitudinal plane of the vehicle. At the end opposite the trailer hitch structural member (48) is fabricated or bent perpendicular or near perpendicular to the portion attached to the vehicle and projects perpendicular or near perpendicular to the horizontal plane of the vehicle. Structural member (48) consists of a singular or a plurality of structural components. Attached to the portion of structural member (48) that is perpendicular or near perpendicular to the horizontal plane of the vehicle is a hinge (49) with an axis of rotation parallel or near parallel to the longitudinal axis of the vehicle and around hinge pin (50). Attached to said hinge is structural member (51) that rotates about said hinge pin and is perpendicular or near perpendicular to the horizontal plane of the vehicle and is secured in position by a pin or similar device (52). Attached to structural member (51) is a planar display (53). Refer to FIG. 12. This invention attaches to the vehicle by means of a structural member (55) that is a removable male plug that engages the trailer hitch with a square, rectangular, or round tubular female receptacle and is secured in place with a pin or similar device (54). The structural member (55) of the display support device that is a removable male plug when attached to the vehicle projects parallel or near parallel to the horizontal plane of the vehicle and parallel or near parallel to the vertical longitudinal plane of the vehicle. At the end opposite the trailer hitch structural member (55) is fabricated or bent perpendicular or near perpendicular to the portion attached to the vehicle and projects perpendicular or near perpendicular to the horizontal plane of the vehicle. Structural member (55) consists of a singular or a plurality of structural components. Attached to the portion of structural member (55) that is perpendicular or near perpendicular to the horizontal plane of the vehicle is a hinge (56) with an axis of rotation parallel or near parallel to the longitudinal axis of the vehicle and around hinge pin (57). Attached to said hinge is structural member (58) that rotates about said hinge pin and is perpendicular or near perpendicular to the horizontal plane of the vehicle and is secured in position by a pin or similar device (59). Attached to structural member (58) is a planar display (60).

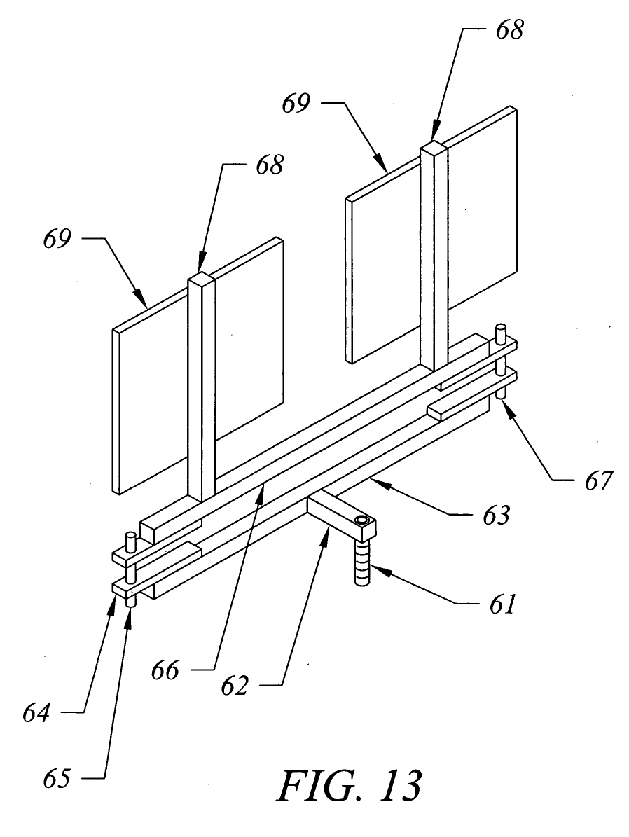

Refer to FIG. 13. This invention attaches to the vehicle by means of the hitch ball receiver and is fastened to the vehicle by means of a threaded fastener (61) that engages the hitch ball receiver and the display support device. The structural member (62) of the display support device attached to the vehicle projects parallel or near parallel to the horizontal plane of the vehicle and parallel or near parallel to the vertical longitudinal plane of the vehicle. Attached to the end opposite the trailer hitch or attached to the surface of structural member (62) is structural member (63) projecting parallel or near parallel to the horizontal plane of the vehicle and perpendicular or near perpendicular to the vertical longitudinal plane of the vehicle. Attached to structural member (63) is a hinge (64) with an axis of rotation perpendicular or near perpendicular to the horizontal plane of the vehicle and around hinge pin (65). Attached to said hinge is structural member (66) that rotates about said hinge pin and projects parallel or near parallel to the horizontal plane of the vehicle and perpendicular or near perpendicular to the vertical longitudinal plane of the vehicle and is secured in position by a pin or similar device (67). Attached to structural member (66) is a singular or a plurality of structural members (68) projecting perpendicular or near perpendicular to the horizontal plane of the vehicle. Attached to or supported between structural members (68) is a singular planar display or a plurality of planar displays (69).

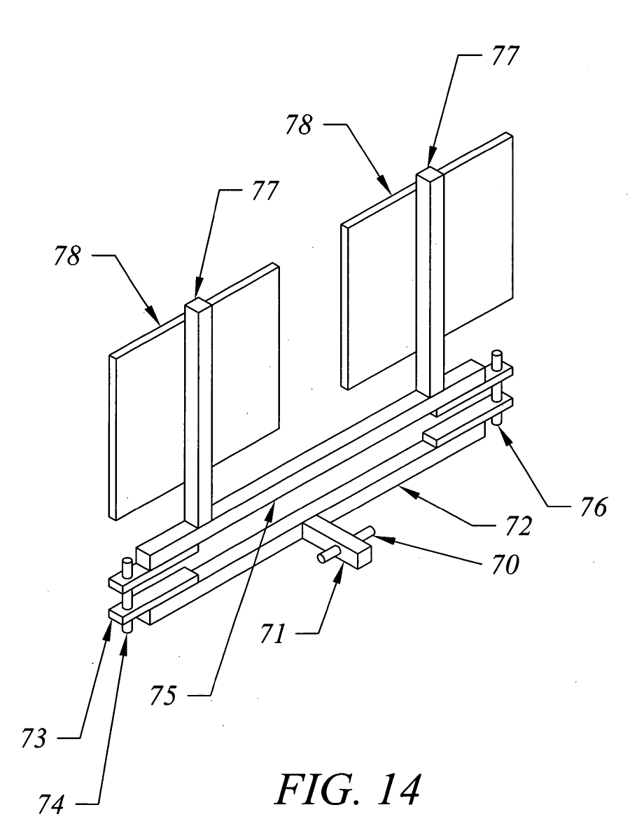

Refer to FIG. 14. This invention attaches to the vehicle by means of a structural member (71) that is a removable male plug that engages the trailer hitch with a square, rectangular, or round tubular female receptacle and is secured in place with a pin or similar device (70). The structural member of the display support device (71) that is a removable male plug when attached to the vehicle projects parallel or near parallel to the horizontal plane of the vehicle and parallel or near parallel to the vertical longitudinal plane of the vehicle. Attached to the end opposite the trailer hitch or attached to the surface of structural member (71) is structural member (72) projecting parallel or near parallel to the horizontal plane of the vehicle and perpendicular or near perpendicular to the vertical longitudinal plane of the vehicle. Attached to structural member (72) is a hinge (73) with an axis of rotation perpendicular or near perpendicular to the horizontal plane of the vehicle and around hinge pin (74). Attached to said hinge is structural member (75) that rotates about said hinge pin and projects parallel or near parallel to the horizontal plane of the vehicle and perpendicular or near perpendicular to the vertical longitudinal plane of the vehicle and is secured in position by a pin or similar device (76). Attached to structural member (75) is a singular or a plurality of structural members (77) projecting perpendicular or near perpendicular to the horizontal plane of the vehicle. Attached to or supported between structural members (77) is a singular planar display or a plurality of planar displays (78).

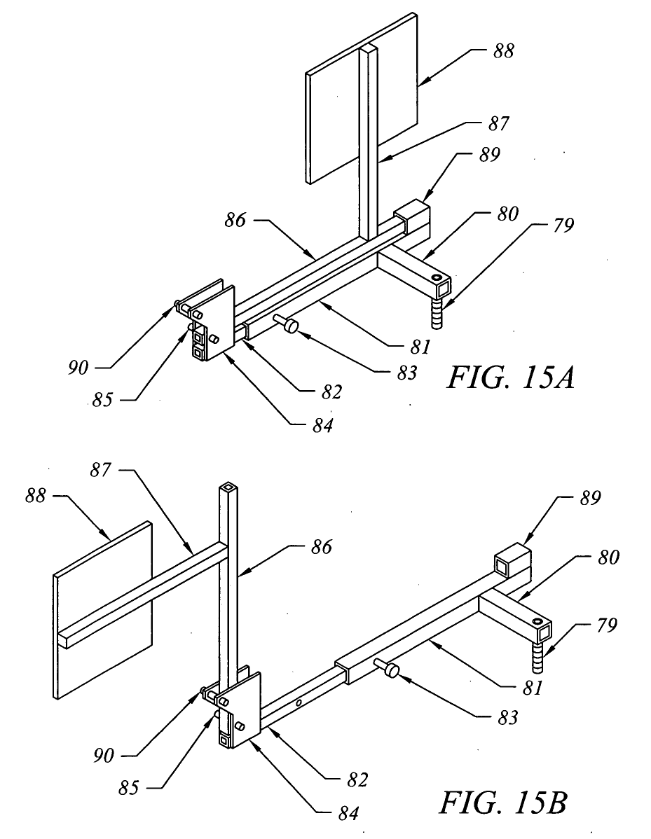

Refer to FIG. 15A. This invention attaches to the vehicle by means of the hitch ball receiver and is fastened to the vehicle by means of a threaded fastener (79) that engages the hitch ball receiver and the display support device. The structural member (80) of the display support device attached to the vehicle projects parallel or near parallel to the horizontal plane of the vehicle and parallel or near parallel to the vertical longitudinal plane of the vehicle. Attached to the end opposite the trailer hitch or attached to the surface of structural member (80) is a structural member (81) projecting parallel or near parallel to the horizontal plane of the vehicle and perpendicular or near perpendicular to the vertical longitudinal plane of the vehicle. Associated with structural member (81) is structural member (82) that projects parallel or near parallel to the structural member (81) and is related to structural member (81) by means of a linear motion device, mechanism or interface. The movement of structural member (82) relative to structural member (81) is prevented by retaining pin (83) which engages both structural members (81) and (82). Attached to structural member (82) is hinge (84). Attached to hinge (84) is hinge pin (85). Attached to hinge (84) by means of hinge pin (85) is structural member (86) that projects parallel or near parallel to the structural members (81) and (82). Attached to structural member (86) is a structural member (87) projecting perpendicular or near perpendicular to structural member (86). Attached to structural member (87) is planer display (88). Structural member (86) is prevented from rotating about hinge pin (85) by the engagement of structural member (86) and structural member (89) where structural member (86) is a male plug and structural member (89) is a female receptacle. Structural member (89) is attached to structural member (81).

Refer to FIG. 15B. Upon removal or release of retaining pin (83) structural member (82) moves in a linear manner parallel or near parallel relative to structural member (81). During this movement structural member (86) disengages from structural member (89). Upon full extension or a portion thereof, structural member (86) that is attached to structural member (82) by means hinge (84) and hinge pin (85) is free to rotate about hinge pin (85). Structural member (86) rotates about hinge pin (85) to a position over the center of hinge pin (85) and is prevented from further rotation and held in position by stop pin (90). Upon full extension the motion of structural member (82) relative to structural member (81) is stopped by retaining pin (83) and the position of structural member (81) relative to structural member (82) is maintained by retaining pin (83).

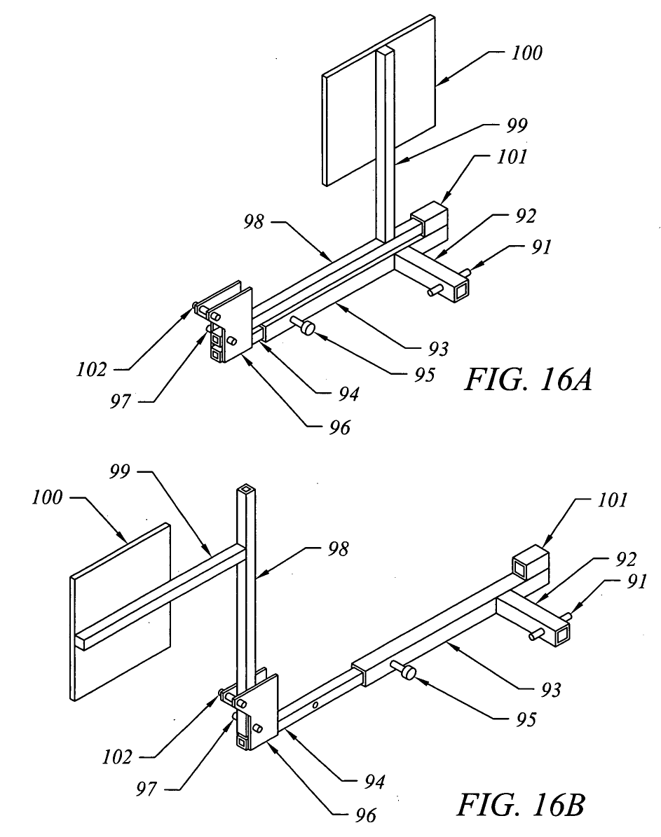

Refer to FIG. 16A. This invention attaches to the vehicle by means of a structural member (92) that is a removable male plug that engages the trailer hitch with a square, rectangular, or round tubular female receptacle and is secured in place with a pin or similar device (91). The structural member (92) of the display support device that is a removable male plug when attached to the vehicle projects parallel or near parallel to the horizontal plane of the vehicle and parallel or near parallel to the vertical longitudinal plane of the vehicle. Attached to the end opposite the trailer hitch or attached to the surface of structural member (92) is a structural member (93) projecting parallel or near parallel to the horizontal plane of the vehicle and perpendicular or near perpendicular to the vertical longitudinal plane of the vehicle. Associated with structural member (93) is structural member (94) that projects parallel or near parallel to the structural member (93) and is related to structural member (93) by means of a linear motion device, mechanism or interface. The movement of structural member (94) relative to structural member (93) is prevented by retaining pin (95) which engages both structural members (93) and (94). Attached to structural member (94) is hinge (96). Attached to hinge (96) is hinge pin (97). Attached to hinge (96) by means of hinge pin (97) is structural member (98) that projects parallel or near parallel to the structural members (93) and (94). Attached to structural member (98) is a structural member (99) projecting perpendicular or near perpendicular to structural member (98). Attached to structural member (99) is planer display (100). Structural member (98) is prevented from rotating about hinge pin (97) by the engagement of structural member(98) and structural member (101) where structural member (98) is a male plug and structural member (101) is a female receptacle. Structural member (101) is attached to structural member (93).

Refer to FIG. 16B. Upon removal or release of retaining pin (95) structural member (94) moves in a linear manner parallel or near parallel relative to structural member (93). During this movement structural member (98) disengages from structural member (101). Upon full extension or a portion thereof, structural member (98) that is attached to structural member (94) by means hinge (96) and hinge pin (97) is free to rotate about hinge pin (97). Structural member (98) rotates about hinge pin (97) to a position over the center of hinge pin (97) and is prevented from further rotation and held in position by stop pin (102). Upon full extension the motion of structural member (94) relative to structural member (93) is stopped by retaining pin (95) and the position of structural member (93) relative to structural member (94) is maintained by retaining pin (95).

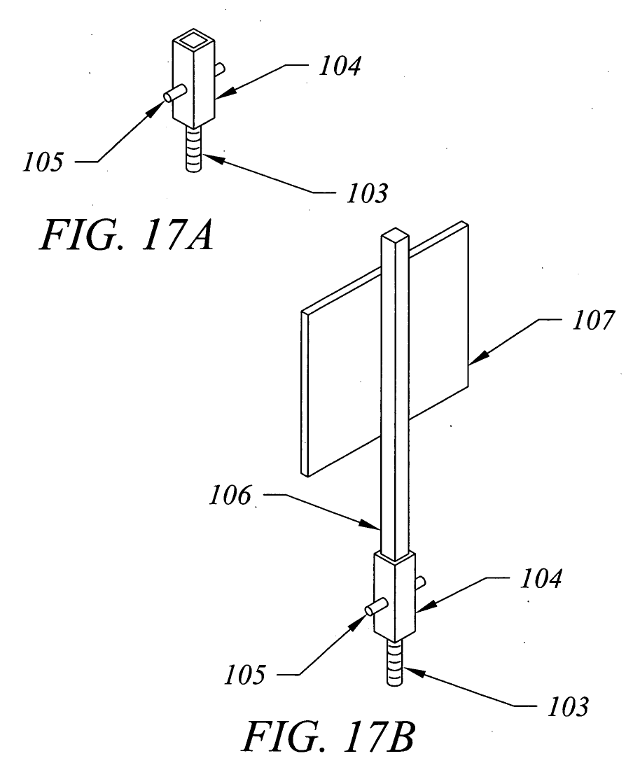

Refer to FIG. 17A. This invention attaches to the vehicle by means of the hitch ball receiver and is fastened to the vehicle by means of a threaded fastener (103) that engages the hitch ball receiver and the display support device. The structural member (104) of the display support device attached to the vehicle projects perpendicular or near perpendicular to the horizontal plane of the vehicle and coaxial or near coaxial to the centerline of the bore of the hitch ball receiver and is a square, rectangular, or round tubular female receptacle. Projecting through the tubular female receptacle (104) is a removable pin or similar device (105).

Refer to FIG. 17B. A post (106) to which a planar display (107) is attached engages the inside of the tubular female receptacle (104) and is retained and secured by the removable pin or similar device (105).

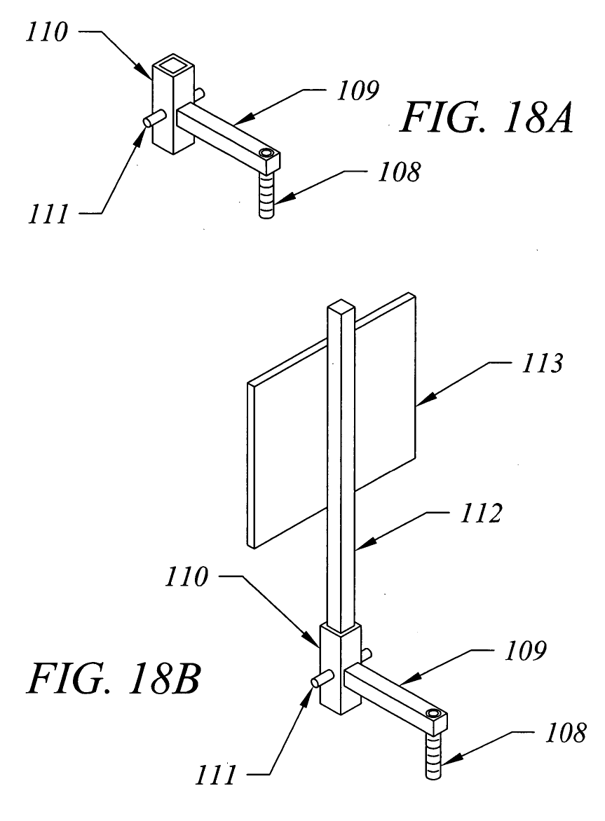

Refer to FIG. 18A. This invention attaches to the vehicle by means of the hitch ball receiver and is fastened to the vehicle by means of a threaded fastener (108) that engages the hitch ball receiver and the display support device. The structural member (109) of the display support device attached to the vehicle projects parallel or near parallel to the horizontal plane of the vehicle and parallel or near parallel to the vertical longitudinal plane of the vehicle. Attached to the end opposite the trailer hitch or attached to the surface of structural member (109) is a structural member (110) projecting perpendicular or near perpendicular to the horizontal plane of the vehicle and parallel or near parallel to the vertical longitudinal plane of the vehicle and is a square, rectangular, or round tubular female receptacle. Projecting through the tubular female receptacle (110) is a removable pin or similar device (111).

Refer to FIG. 18B. A post (112) to which a planar display (113) is attached engages the inside of the tubular female receptacle (110) and is retained and secured by the removable pin or similar device (111).

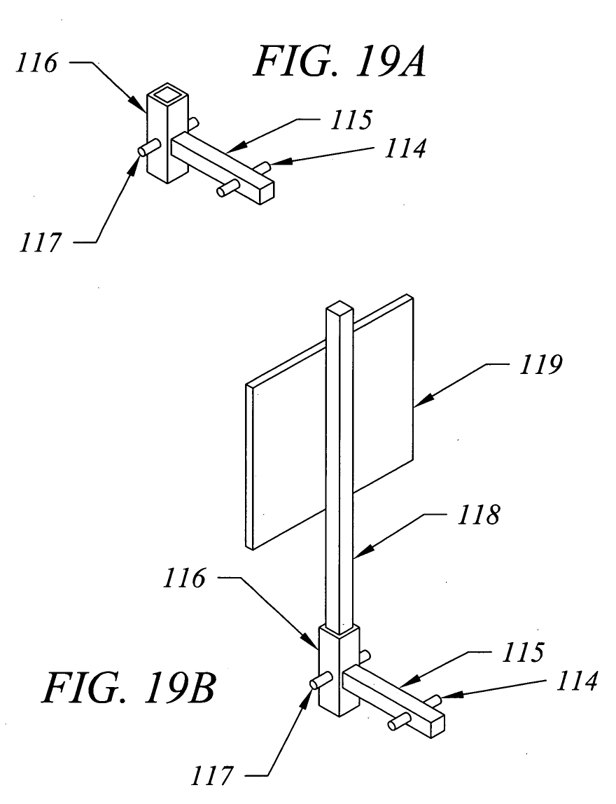

Refer to FIG. 19A. This invention attaches to the vehicle by means of a structural member (115) that is a removable male plug that engages the trailer hitch with a square, rectangular, or round tubular female receptacle and is secured in place with a pin or similar device (114). The structural member (115) of the display support device that is a removable male plug when attached to the vehicle projects parallel or near parallel to the horizontal plane of the vehicle and parallel or near parallel to the vertical longitudinal plane of the vehicle. Attached to the end opposite the trailer hitch or attached to the surface of structural member (115) is a structural member (116) projecting perpendicular or near perpendicular to the horizontal plane of the vehicle and parallel or near parallel to the vertical longitudinal plane of the vehicle and is a square, rectangular, or round tubular female receptacle. Projecting through the tubular female receptacle (116) is a removable pin or similar device (117).

Refer to FIG. 19B. A post (118) to which a planar display (119) is attached engages the inside of the tubular female receptacle (116) and is retained and secured by the removable pin or similar device (117).

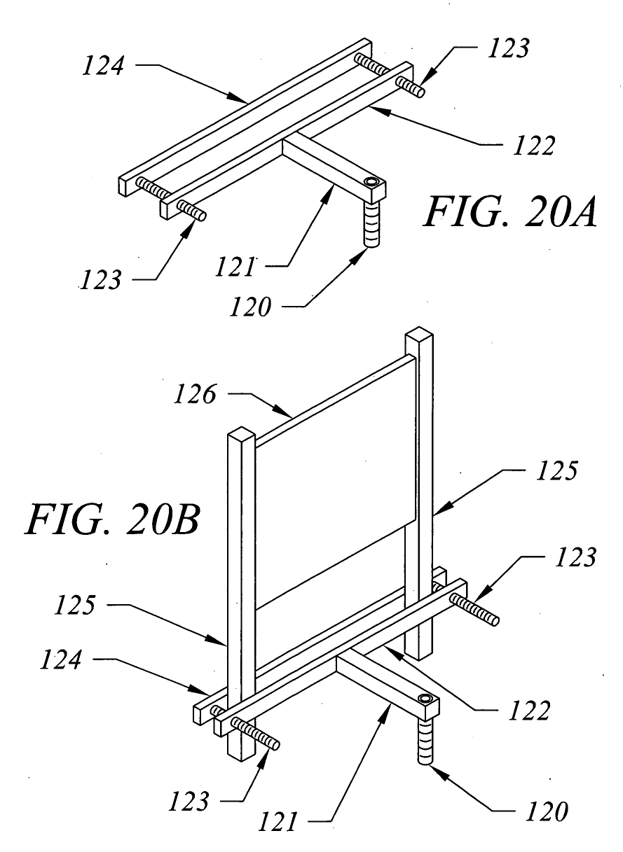

Refer to FIG. 20A. This invention attaches to the vehicle by means of the hitch ball receiver and is fastened to the vehicle by means of a threaded fastener (120) that engages the hitch ball receiver and the display support device. The structural member (121) of the display support device attached to the vehicle projects parallel or near parallel to the horizontal plane of the vehicle and parallel or near parallel to the vertical longitudinal plane of the vehicle. Attached to the end opposite the trailer hitch or attached to the surface of structural member (121) is a structural member (122) projecting parallel or near parallel to the horizontal plane of the vehicle and perpendicular or near perpendicular to the vertical longitudinal plane of the vehicle. At either end of structural member (122) are clearance or threaded holes through structural member (122) that engage threaded fasteners (123). Parallel to structural member (122) is structural member (124). At either end of structural member (124) are clearance or threaded holes through structural member (124) that engage threaded fasteners (123). Structural members (122) and (124) are joined by means of threaded fasteners (123) and converge and recede relative to each other by employing threaded fasteners (123).

Refer to FIG. 20B. A singular or a plurality of posts (125) to which a planar display (126) is attached engages structural members (122) and (124) as structural members (122) and (124) converge as the threaded fasteners (123) are tightened and are retained and secured by structural members (122) and (124) by the forces exerted by the threaded fasteners (123).

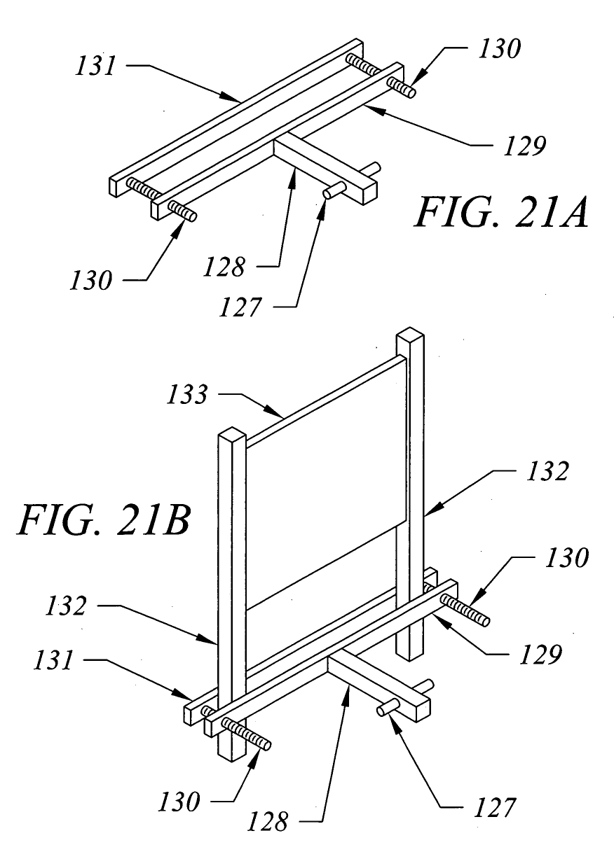

Refer to FIG. 21A. This invention attaches to the vehicle by means of a structural member (128) that is a removable male plug that engages the trailer hitch with a square, rectangular, or round tubular female receptacle and is secured in place with a pin or similar device (127). The structural member (128) of the display support device that is a removable male plug when attached to the vehicle projects parallel or near parallel to the horizontal plane of the vehicle and parallel or near parallel to the vertical longitudinal plane of the vehicle. Attached to the end opposite the trailer hitch or attached to the surface of structural member (128) is a structural member (129) projecting parallel or near parallel to the horizontal plane of the vehicle and perpendicular or near perpendicular to the vertical longitudinal plane of the vehicle. At either end of structural member (129) are clearance or threaded holes through structural member (129) that engage threaded fasteners (130). Parallel to structural member (129) is structural member (131). At either end of structural member (131) are clearance or threaded holes through structural member (131) that engage threaded fasteners (130). Structural members (129) and (131) are joined by means of threaded fasteners (130) and converge and recede relative to each other by employing threaded fasteners (130).

Refer to FIG. 21B. A singular or a plurality of posts (132) to which a planar display (133) is attached engages structural members (129) and (131) as structural members (129) and (131) converge as the threaded fasteners (130) are tightened and are retained and secured by structural members (129) and (131) by the forces exerted by the threaded fasteners (130).

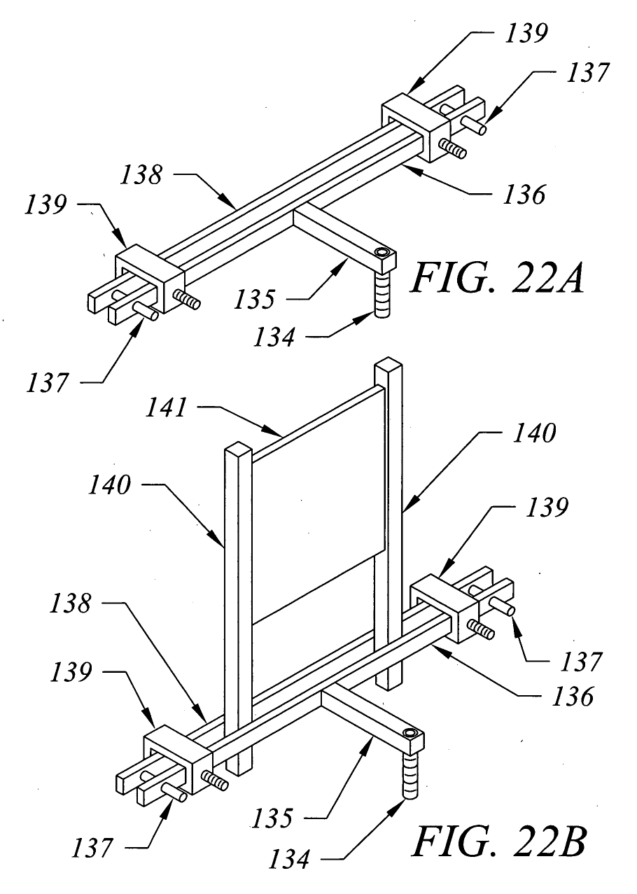

Refer to FIG. 22A. This invention attaches to the vehicle by means of the hitch ball receiver and is fastened to the vehicle by means of a threaded fastener (134) that engages the hitch ball receiver and the display support device. The structural member (135) of the display support device attached to the vehicle projects parallel or near parallel to the horizontal plane of the vehicle and parallel or near parallel to the vertical longitudinal plane of the vehicle. Attached to the end opposite the trailer hitch or attached to the surface of structural member (135) is a structural member (136) projecting parallel or near parallel to the horizontal plane of the vehicle and perpendicular or near perpendicular to the vertical longitudinal plane of the vehicle. At either end of structural member (136) are clearance holes through which guide pins (137) move. Parallel to structural member (136) is structural member (138). At either end of structural member (138) guide pins (137) attach. Structural members (136) and (138) are joined by means of guide pins (137) and clamping devices (139).

Refer to FIG. 22B. A singular or a plurality of posts (140) to which a planar display (141) is attached engages structural members (136) and (138) as structural members (136) and (138) converge as the clamping devices (139) are actuated and are retained and secured by structural members (136) and (138) by the forces exerted by the clamping devices (139).

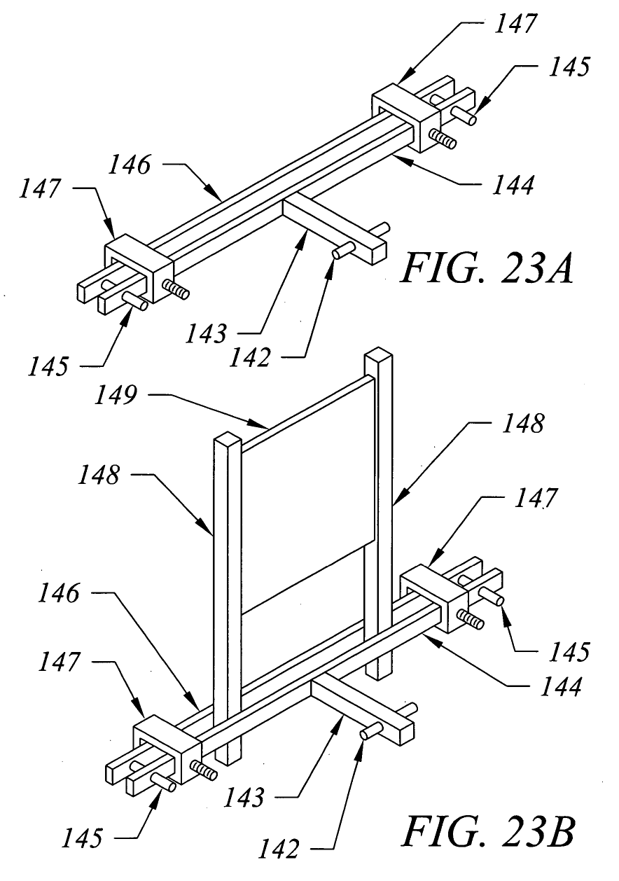

Refer to FIG. 23A. This invention attaches to the vehicle by means of a structural member (143) that is a removable male plug that engages the trailer hitch with a square, rectangular, or round tubular female receptacle and is secured in place with a pin or similar device (142). The structural member (143) of the display support device that is a removable male plug when attached to the vehicle projects parallel or near parallel to the horizontal plane of the vehicle and parallel or near parallel to the vertical longitudinal plane of the vehicle. Attached to the end opposite the trailer hitch or attached to the surface of structural member (143) is a structural member (144) projecting parallel or near parallel to the horizontal plane of the vehicle and perpendicular or near perpendicular to the vertical longitudinal plane of the vehicle. At either end of structural member (144) are clearance holes through which guide pins (145) move. Parallel to structural member (144) is structural member (146). At either end of structural member (146) guide pins (145) attach. Structural members (144) and (146) are joined by means of guide pins (145) and clamping devices (147).

Refer to FIG. 23B. A singular or a plurality of posts (148) to which a planar display (149) is attached engages structural members (144) and (146) as structural members (144) and (146) converge as the clamping devices (147) are actuated and are retained and secured by structural members (144) and (146) by the forces exerted by the clamping devices (147).

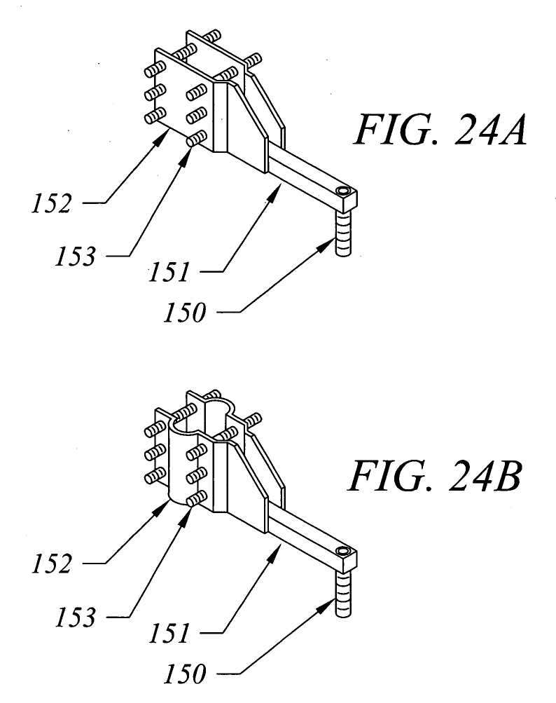

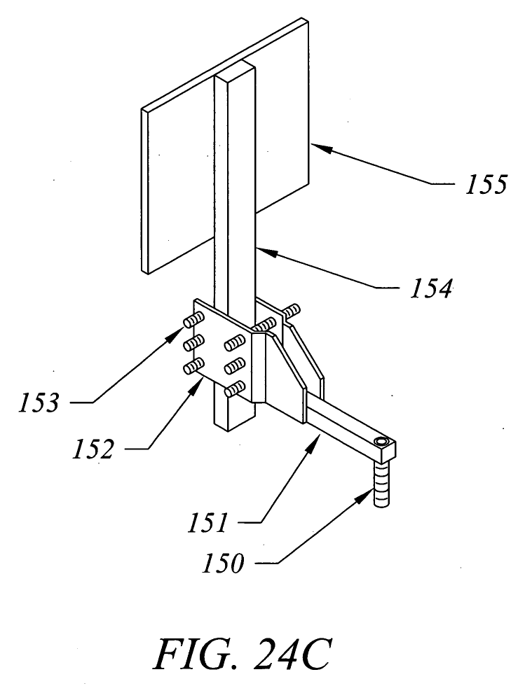

Refer to FIGS. 24A and 24B. This invention attaches to the vehicle by means of the hitch ball receiver and is fastened to the vehicle by means of a threaded fastener (150) that engages the hitch ball receiver and the display support device. The structural member (151) of the display support device attached to the vehicle projects parallel or near parallel to the horizontal plane of the vehicle and parallel or near parallel to the vertical longitudinal plane of the vehicle. Attached to either side of structural member (151) and cantilevering beyond the end of structural member (151) are plates (152). Plates (152) have a plurality of clearance or threaded holes that engage threaded fasteners (153). The plates (152) can be flat as shown in Figure A or shaped as shown in Figure B. The shaped plates can possess any geometric shape.

Refer to FIG. 24C. A singular post (154) to which a planar display (155) is attached engages plates (152) as plates (152) converge as the threaded fasteners (153) are tightened and is retained and secured by plates (152) by the forces exerted by the tightened threaded fasteners (153).

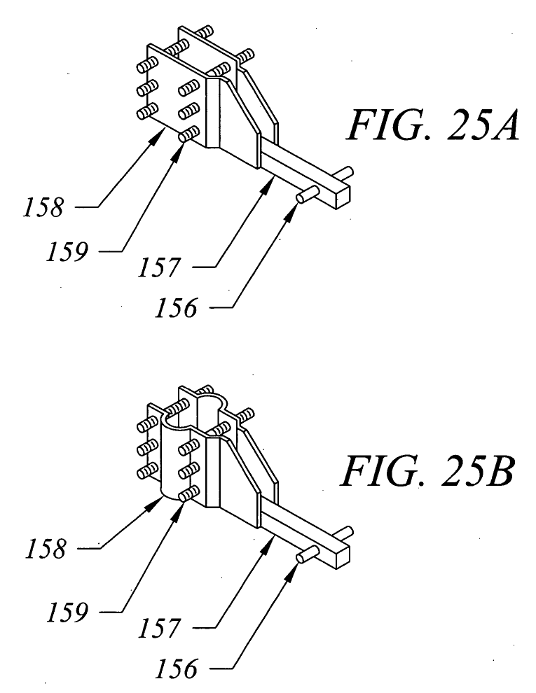

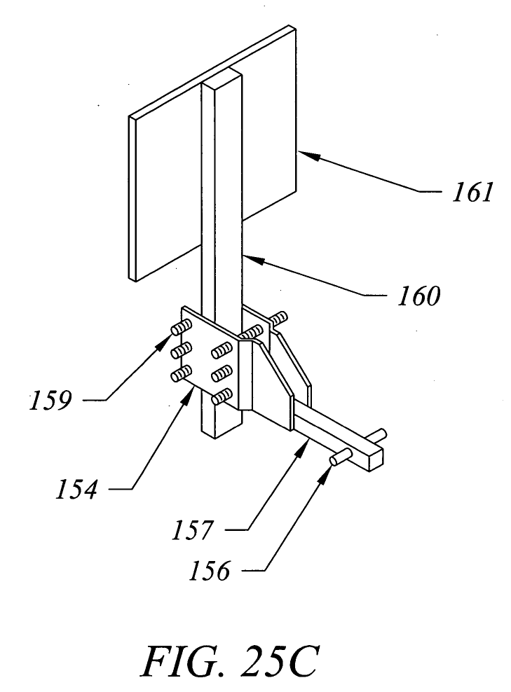

Refer to FIGS. 25A and 25B. This invention attaches to the vehicle by means of a structural member (157) that is a removable male plug that engages the trailer hitch with a square, rectangular, or round tubular female receptacle and is secured in place with a pin or similar device (156). The structural member (157) of the display support device that is a removable male plug when attached to the vehicle projects parallel or near parallel to the horizontal plane of the vehicle and parallel or near parallel to the vertical longitudinal plane of the vehicle. Attached to either side of structural member (157) and cantilevering beyond the end of structural member (157) are plates (158). Plates (158) have a plurality of clearance or threaded holes that engage threaded fasteners (159). The plates (158) can be flat as shown in Figure A or shaped as shown in Figure B. The shaped plates can possess any geometric shape.

Refer to FIG. 25C. A singular post (160) to which a planar display (161) is attached engages plates (158) as plates (158) converge as the threaded fasteners (159) are tightened and is retained and secured by plates (158) by the forces exerted by the tightened threaded fasteners (159).

I claim:

1. A vehicular display support device configured to act as or support a singular post or a plurality of posts and configured for suspension from a fixed trailer hitch receiver, a fixed or unfixed trailer hitch ball receiver, a fixed step bumper hitch ball receiver, or a fixed tongue hitch ball receiver in order to present a planer display or planer displays in a plane parallel to the front and rear surfaces of a vehicle, comprising:
an articulating or a non-articulating structural device supporting a singular post or a plurality of posts;
a planer display or a frame to support a planer display;
a structural support member being coaxially captivated by said fixed trailer hitch receiver, fastened to said fixed or unfixed trailer hitch ball receiver, fastened to said fixed step bumper hitch ball receiver, fastened to said fixed tongue hitch ball receiver;
an apparatus for transferring electrical power from a power source to a planer display or a frame supporting a planer display;
an apparatus for transferring electronic information from an electronic information source to a planer display or a frame supporting a planer display;
an apparatus for transferring an electrical signal from an electrical signal source to a planer display or a frame supporting a planer display.

2. The device of claim 1 wherein said vehicular display support device comprises of at least one structural member.

3. The device of claim 1 wherein said vehicular display support device comprises of at least two concatenated structural members.

4. The device of claim 1 wherein said vehicular display support device comprises of at least one planer display or frame to support a planer display with said planer display or said frame fastened to said structural member.

5. The device of claim 4 wherein said planer display or said frame fastens to said structural member at multiple positions on said structural member.

6. The device of claim 4 wherein said frame comprises of at least two concatenated members.

7. The device of claim 1 wherein said articulating structural device articulates in a rotational manner, articulates in a linear manner, or articulates in a rotational and a linear manner.

8. The device of claim 7 wherein the articulation in a rotational manner is achieved with the use of a singular rotational apparatus or plurality of rotational apparatuses or a singular ball and socket apparatus or plurality of ball and socket apparatuses.

9. The device of claim 7 wherein the articulation in a linear manner is achieved with the use of a singular linear motion apparatus or plurality of linear motion apparatuses.

10. The device of claim 1 wherein said structural support member is fashioned to fit into said fixed trailer hitch receiver.

11. The device of claim 1 wherein said structural support member is fashioned to attach to said fixed or unfixed trailer hitch ball receiver, said fixed step bumper hitch ball receiver, or said fixed tongue hitch ball receiver.

12. The device of claim 1 wherein said structural device is comprised of man made and natural materials.

13. The device of claim 1 wherein a spoiler attaches to said structural member or to said planer display or to said frame to disrupt the air flow in the proximity of said planer display or said frame.

14. The device of claim 1 wherein said apparatus for transferring electrical power provides electrical power to electrical and electromechanical appliances, said electrical and electromechanical appliances being attached to or a member of said plainer display or said frame.

15. The device of claim 1 wherein said apparatus for transferring electronic information provides electronic information to electronic appliances, said electronic appliances being attached to or a member of said plainer display or said frame.

16. The device of claim 1 wherein said apparatus for transferring an electrical signal provides an electrical signal to electrical and electronic appliances, said electrical and electronic appliances being attached to or a member of said plainer display or said frame.

17. The device of claim 1 wherein said vehicular display support device configured to support a singular post or a plurality of posts does so by means of a clamping apparatus or clamping apparatuses.

18. The device of claim 1 wherein said vehicular display support device configured to support a singular post or a plurality of posts does so by means of an apparatus comprised of a singular or plurality of male plugs and female receivers with pins, clamps, or threaded fasteners providing retention.

19. The device of claim 1 wherein said vehicular display support device configured to support a singular post or a plurality of posts does so by means of an apparatus comprised of a singular or plurality of threaded male plugs and threaded female receivers with pins, clamps, or threaded fasteners providing retention.

20. The device of claim 1 wherein said structural support member is fashioned to accept a chain or similar device for the purpose of attachment to the bearing vehicle and serving as a safety device.
